(19) United States
(12) Patent Application Publication
(10) Pub. No.: US 2022/0207934 A1
(43) Pub. Date: Jun. 30, 2022

(54) PARTICULAR-DRIVING-OPERATION IDENTIFICATION SYSTEM

(71) Applicant: TOYOTA JIDOSHA KABUSHIKI KAISHA, Toyota-shi (JP)

(72) Inventors: Atsushi TABATA, Okazaki-shi (JP); Masafumi YAMAMOTO, Nagakute-shi (JP); Koichi OKUDA, Toyota-shi (JP); Yuuki MAKINO, Aichi-gun (JP)

(73) Assignee: TOYOTA JIDOSHA KABUSHIKI KAISHA, Toyota-shi (JP)

(21) Appl. No.: 17/562,189

(22) Filed: Dec. 27, 2021

(30) Foreign Application Priority Data
Dec. 24, 2020 (JP) 2020-215822

(51) Int. Cl. G07C 5/08

(52) U.S. Cl. CPC G07C 5/0808; G07C 5/085

(57) ABSTRACT

A particular-driving-operation identification system for identifying whether a failure or a durability reduction of a component installed in a vehicle has been caused by a driving operation of an occupant of the vehicle or not. The system includes a particular-driving-operation identification portion configured to determine whether there has been a particular driving operation that is the driving operation likely to cause the failure or the durability reduction of the component, based on a driving-operation data. When determining that there has been the particular driving operation in a case in which the failure or the durability reduction of the component has been caused, the particular-driving-operation identification portion identifies, based on a vehicle-state data related to the vehicle state, whether the failure or the durability reduction of the component has been caused by the particular driving operation or not depending on the vehicle state when the particular driving operation has been executed.

This application claims priority from Japanese Patent Application No. 2020-215822 filed on Dec. 24, 2020, the disclosure of which is herein incorporated by reference in its entirety.

### FIELD OF THE INVENTION

The present invention relates to a particular-driving-operation identification system for identifying whether a failure or a durability reduction of a component installed in a vehicle has been caused by a driving operation of an occupant of the vehicle.

### BACKGROUND OF THE INVENTION

In JP-2005-53373A, there are proposed arrangements in which, when a failure has occurred in a vehicle or when a vehicle occupant has made an erroneous operation in the vehicle, a processing is executed to impose a limitation on control operations in the vehicle, and a content of the imposed limitation is informed to the vehicle occupant.

### SUMMARY OF THE INVENTION

By the way, the processing for imposing the limitation on the control operations is not executed depending on a content of the operation of the vehicle occupant, so that a failure or a durability reduction of a component installed in the vehicle could be caused. For coping with such an issue, it is desirable to identify whether the failure or durability reduction of the component has been caused by a particular driving operation executed by the vehicle occupant. Therefore, it is an object to identify whether the failure or durability reduction of the component installed in the vehicle has been caused by the driving operation executed by the vehicle occupant when the failure or durability induction occurs.

The present invention was made in view of the background art described above. It is therefore an object of the present invention to provide a particular-driving-operation identification system for identifying whether a failure or a durability reduction of a component installed in a vehicle has been caused by a driving operation of an occupant of the vehicle.

The object indicated above is achieved according to the following aspects of the present invention.

According to a first aspect of the invention, there is provided a particular-driving-operation identification system for identifying whether a failure or a durability reduction of a component installed in a vehicle has been caused by a driving operation of an occupant of the vehicle or not, the particular-driving-operation identification system comprising: (a) a data storage portion configured to store therein a driving-operation data related to the driving operation of the vehicle occupant and a vehicle-state data related to a vehicle state that is a state of the vehicle; and (b) a particular-driving-operation identification portion configured to determine whether there has been a particular driving operation that is the driving operation likely to cause the failure or the durability reduction of the component, based on the driving-operation data stored in the data storage portion, wherein, when determining that there has been the particular driving operation in a case in which the failure or the durability reduction of the component has been caused, the particular-driving-operation identification portion is configured to identify, based on the vehicle-state data stored in the data storage portion, whether the failure or the durability reduction of the component has been caused by the particular driving operation or not, depending on the vehicle state when the particular driving operation has been executed.

The particular-driving-operation identification system may further comprises: (c) a failure/durability-reduction detection portion configured to detect the failure or the durability reduction of the component; and (d) a vehicle-state detection portion configured to acquire the vehicle-stale data and detect the vehicle state when the particular driving operation has been executed, wherein the particular-driving-operation identification portion is configured to determine that the failure or the durability reduction of the component detected by the failure durability-reduction detection portion has been caused by the executed particular driving operation, when determining that the vehicle state detected by vehicle-state detection portion has been caused by execution of the particular driving operation and has caused the failure or the durability reduction of the component detected by the failure/durability-reduction detection portion.

According to a second aspect of the invention, in the particular-driving-operation identification system according to the first aspect of the invention, the driving-operation data is to be acquired based on an image data related to an image of the vehicle occupant.

According to a third aspect of the invention, in the particular-driving-operation identification system according to the first aspect of the invention, the driving-operation data is to be acquired based on a sound data related to a voice or a conversation of the vehicle occupant.

According to a fourth aspect of the invention, in the particular-driving-operation identification system according to any one of the first through third aspects of the invention, the particular-driving-operation identification portion is configured to pre-store therein at least one driving operation each corresponding to the particular driving operation, and is configured to determine that there has been the particular driving operation, when at least one of the at least one driving operation is detected in the driving-operation data.

According to a firth aspect of the invention, in the particular-driving-operation identification system according to any one of the first through fourth aspects of the invention, the particular-driving-operation identification portion is configured to determine whether or not the failure or the durability reduction of the component has been caused by the particular driving operation that is relevant to the failure or the durability reduction of the component, depending on (i) whether a cumulative number of times of execution of the particular driving operation is larger titan a first predetermined value or not. (ii) whether a number of limes of execution of the particular driving operation during running of the vehicle for a predetermined length of time, is larger titan a second predetermined value or not, or (iii) whether a number of times of execution of the particular driving operation during running of the vehicle for a predetermined distance, is larger than a third predetermined value or not.

In the particular-driving-operation identification system according to the first aspect of the invention, it is determined by the particular-driving-operation identification portion whether there has been the particular driving operation that is likely to cause the failure or the durability reduction of the component, based on the driving-operation data stored in the data storage portion. When the failure or durability reduction of the component has been caused, it can be determined whether the failure or the durability reduction of the component has been caused by the particular driving operation or not, depending on the vehicle state when the particular driving operation has been executed.

In the particular-driving-operation identification system according to the second aspect of the invention, the driving-operation data related to the driving operation executed by the vehicle occupant can be acquired based on the image data related to the image of the vehicle occupant.

In the particular-driving-operation identification system according to the third aspect of the invention, the driving-operation data can be acquired based on the sound data related to five voice or the conversation of the vehicle occupant.

In the particular-driving-operation identification system according to the fourth aspect of the invention, when the driving-operation data is acquired, it can be determined whether there has been the particular driving operation, depending on whether at least one of the at least one driving operation each corresponding to the particular driving operation, is detected or oat in the acquired driving-operation data.

In the particular-driving-operation identification system according to the fifth aspect of the invention, it can be determined whether the failure or the durability reduction of a component has been caused by the particular driving operation that is relevant to the failure or the durability reduction of a component, depending on (i) whether the cumulative number of times of execution of the particular driving operation is larger than the first predetermined value or not, (ii) whether the number of limes of execution of the particular driving operation during running of the vehicle for the predetermined length of time, is larger than the second predetermined value or not, or (iii) whether the number of times of execution of the particular driving operation during running of the vehicle for the predetermined distance, is larger than the third predetermined value or not.

### BRIEF DESCRIPTION OF THE DRAWINGS

FIG. 1 is a schematic view showing a construction of a vehicle to which the present invention is applied, and also a construction of a particular-driving-operation identification system for identifying whether a failure or a durability reduction of a component installed in the vehicle has been caused by a driving operation of an occupant of the vehicle;

FIG. 2 is a view for explaining a position of an onboard camera provided in the vehicle;

FIG. 3 is a view showing a driving-operation data representing driving operations that are listed in a chronological order;

FIG. 4 is a view showing a relationship between a running distance of the vehicle and a repeated number of times of execution of a particular driving operation in a case in which the particular driving operation is executed during running of the vehicle:

FIG. 5 is a flow chart for explaining a control routine that is to be executed, when the failure or durability reduction of the component has occurred, for determining whether the failure or durability reduction has been caused by the driving operation executed by the vehicle occupant;

FIG. 6 is a flow chart for explaining a control routine that is to be executed for determining whether there is a possibility that the identified particular driving operation has caused the failure or durability reduction of the component; and

FIG. 7 is an overall construction of a particular-driving-operation identification system according to another embodiment of the present invention.

### DETAILED DESCRIPTION OF PREFERRED EMBODIMENTS

Hereinafter, preferred embodiments of the invention will be described in detail with reference to the accompanying drawings. The figures of the drawings are simplified or deformed as needed, and each portion is not necessarily precisely depicted in terms of dimension ratio, shape, etc.

### First Embodiment

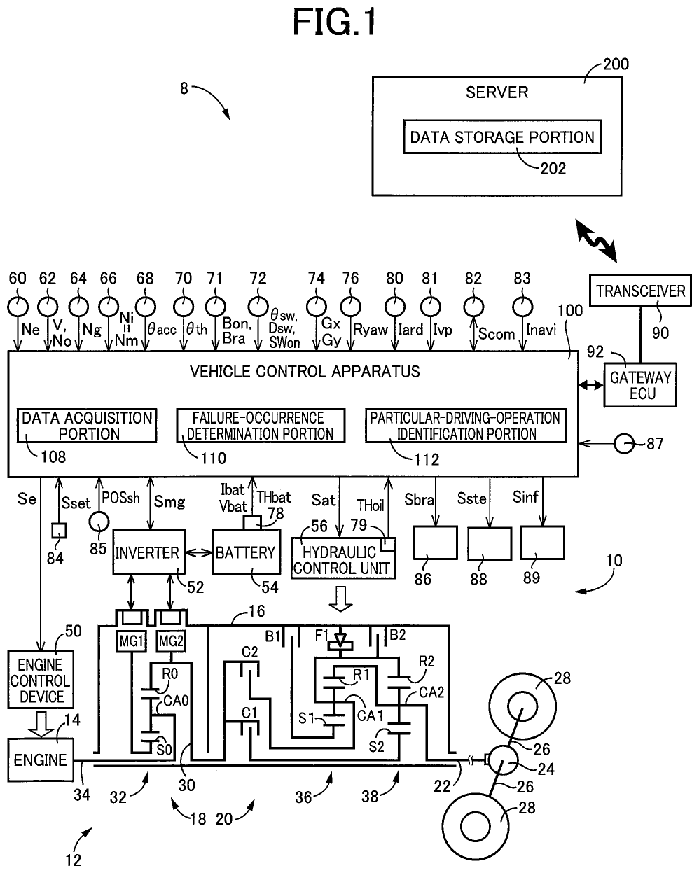

FIG. 1 is a schematic view showing a construction of a vehicle 10 to which the present invention is applied, and also a construction of a particular-driving-operation identification system 8 for identifying whether a failure or a durability reduction of a component installed in the vehicle 10 has been caused by a driving operation of an occupant of the vehicle 10.

The vehicle 10 includes an engine 14, a first rotating machine MG1 and a second rotating machine MG2, and is a hybrid electric vehicle in which the engine 14 and the second rotating machine MG2 serve as drive power sources for driving the vehicle 10. The vehicle 10 further includes a power transmission apparatus 12 that constitutes a drive-power transmission path between the engine 14 and drive wheels 28. The power transmission apparatus 12 includes a casing 16 as a non-rotary member, an electrically-operated continuously-variable transmission portion 18 and a mechanically-operated step-variable transmission portion 20. The continuously-variable transmission portion 18 and the step-variable transmission portion 20 are provided within the casing 16, and are arranged in a series on a common axis. The continuously-variable transmission portion 18 is connected to the engine 14 directly or indirectly through, for example, a damper (not shown). The step-variable transmission portion 20 is connected to an output rotary member of the continuously-variable transmission portion 18. The power transmission apparatus 12 further includes a differential gear device 24 connected to an output shaft 22 that is an output rotary member of the step-variable transmission portion 20, and a pair of axles 26 connected to the differential gear device 24.

In the power transmission apparatus 12, the drive power outputted from the engine 14 or the second rotating machine MG2 is transmitted to the step-variable transmission portion 20, and is then transmitted from the step-variable transmission portion 20 to the drive wheels 28 of the vehicle 10, for example, through the differential gear device 24. It is noted that the power corresponds to a torque or a force unless otherwise distinguished from them. It is also noted that the power transmission apparatus 12 including the continuously-variable transmission portion 18 and the step-variable transmission portion 20 is constructed substantially symmetrically about its axis corresponding to the above-described common axis, so that a lower half of the power transmission apparatus 12 is not shown in FIG. 1.

The engine 14 serves as the drive power source capable of generating a drive torque, and is a known internal combustion engine such as gasoline engine and diesel engine. The vehicle 10 is provided with an engine control device 50 that includes a throttle actuator, a fuel injection device and an ignition device. With the engine control device 50 being controlled, an engine torque Te, which is an output torque of the engine 14, is controlled.

Each of the first and second rotating machines MG1, MG2 is a rotating electric machine having a function serving as an electric motor and a function serving as a generator. That is, each of the first and second rotating machines MG1, MG2 is a so-called “motor generator”. The first and second rotating machines MG1, MG2 are connected to an electric storage device in the form of a battery 54 provided in the vehicle 10, through an inverter 52 provided in the vehicle 10. The inverter 52 is controlled by a vehicle control apparatus 100 whereby an MG1 torque Tg and an MG2 torque Tm as output torques of the respective first and second rotating machines MG1, MG2 are controlled.

The continuously-variable transmission portion 18 is provided with the above-described first rotating machine (first motor generator) MG1; a differential mechanism 32 serving as a drive-force distributing device to mechanically distribute the drive force of the engine 14 to the first rotating machine MG1 and to an intermediate transmission member 30 that is an output rotary member of the continuously-variable transmission portion 18; and a second rotating machine (second motor/generator) MG2 connected to the intermediate transmission member 30 in a drive-force transmittable manner. The differential mechanism 32 is constituted by a planetary gear device of a single-pinion type having a sun gear S0, a carrier CA0 and a ring gear R0. The carrier CA0 is connected to the engine 14 through a connecting shaft 34 in a drive-force transmittable manner, and the sun gear S0 is connected to the first rotating machine MG1 in a drive-force transmittable manner, while the ring gear R0 is connected to the second rotating machine MG2 in a drive-force transmittable manner. The continuously-variable transmission portion 18 is an electrically-controlled continuously-variable transmission where n a differential state of the differential mechanism 32 is controllable by controlling an operation stale of the first rotating machine MG1.

The step-variable transmission portion 20 is a mechanically-operated transmission mechanism which constitutes a part of a drive-power transmitting path between the continuously-variable transmission portion 18 and the drive wheels 28. The step-variable transmission portion 20 is a known automatic transmission of a planetary gear type which is provided with a plurality of planetary gear devices in the form of a first planetary gear device 36 anti a second planetary gear device 38, and a plurality of engagement devices including s clutch C1, a clutch C2, a brake 151 and a brake B2. Hereinafter, the clutch C1, clutch C2, brake B1 and brake 132 will be referred to as “engagement devices CB” unless otherwise specified. Each of the engagement devices CB receives an engagement hydraulic pressure PRcb that is controlled by a hydraulic control unit 56 provided in the vehicle 10. When a gear position is selected, based on an accelerator operation amount (accelerator opening degree θacc) and a running speed V of the vehicle 10, for example, so as to be established in the step-variable transmission portion 20, operation states of the respective engagement devices CB are controlled such that corresponding at least one of the engagement devices CB is engaged for establishing the selected gear position.

The vehicle 10 is provided with the vehicle control apparatus 100 as a controller including control devices which are configured to control, for example, the engine 14, continuously-variable transmission portion 18 and step-variable transmission portion 20. For example, the vehicle control apparatus 100 includes a so-called microcomputer incorporating a CPU, a RAM, a ROM and an input-output interface. The CPU performs control operations of the vehicle 10, by processing various input signals, according to control programs stored in the ROM, while utilizing a temporary data storage function of the RAM. The vehicle control apparatus 100 may be constituted by two or more control units exclusively assigned to perform different control operations such as the engine control operation and the shift control operation.

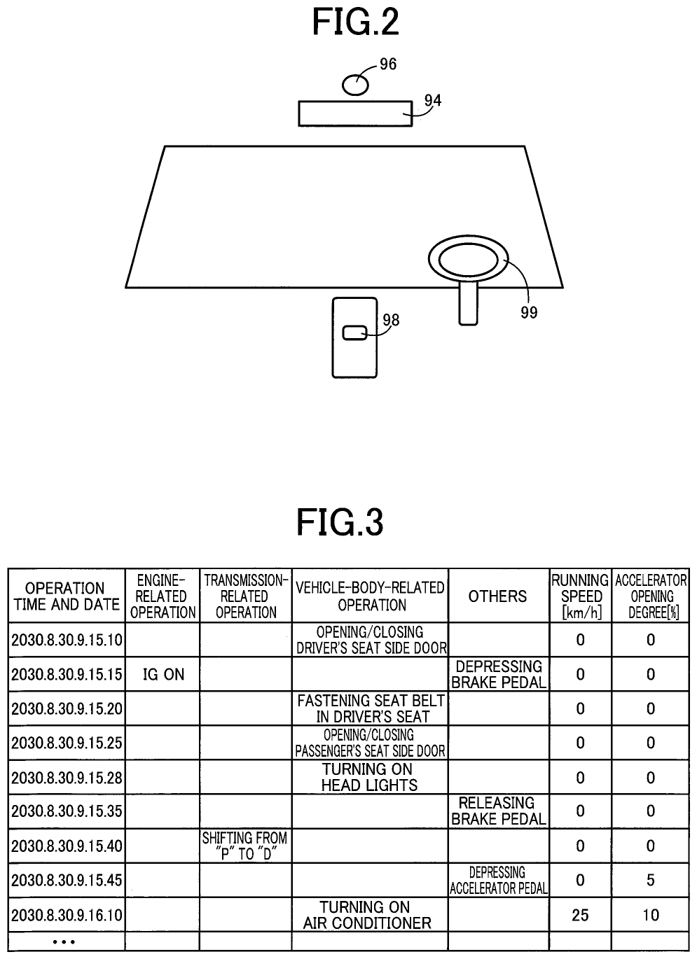

The vehicle control apparatus 100 receives various input signals based on values detected by respective sensors provided in the vehicle 10. Specifically, the vehicle control apparatus 100 receives: an output signal of an engine speed sensor 60 indicative of an engine rotational speed Ne which is a rotational speed of the engine 14; an output signal of an output speed sensor 62 indicative of an output-shaft rotational speed No which is a rotational speed of the output shaft 22 and which corresponds to the running speed V of the vehicle 10; an output signal of a MG1 speed sensor 64 indicative of an MG1 rotational speed Ng which is a rotational speed of the first rotating machine MG1; an output signal of a MG2 speed sensor 66 indicative of an MG2 rotational speed Nm which is a rotational speed of the second rotating machine MG2 and which corresponds to an AT input rotational speed Ni; an output signal of an accelerator-opening degree sensor 68 indicative of an acceleration opening degree θacc representing an amount of accelerating operation made by the vehicle driver: an output signal of a throttle-opening degree sensor 70 indicative of a throttle opening degree θth; an output signal of a brake pedal sensor 71 indicative of a brake-ON signal Bon representing a state of depression of a brake pedal by the vehicle driver to operate wheel brakes and also a braking operation amount Bra representing an amount of depression of the brake pedal by the vehicle driver corresponding to a depressing force applied to the brake pedal; an output signal of a steering sensor 72 indicative of a steering angle θsw and a steering direction Dsw of a steering wheel 99 (see FIG. 2) provided in the vehicle 10 and also a steering ON signal SWon representing a state in which the steering wheel is being held by the vehicle driver: an output signal of a G senor 74 indicative of a longitudinal acceleration Gx and a lateral acceleration Gy of the vehicle 10; an output signal of a yaw rate sensor 76 indicative of a yaw rate Ryaw that is an angular speed around a vertical axis of the vehicle 10; an output signal of a battery sensor 78 indicative of a battery temperature TMba, a charging discharging electric current Ibat and a voltage Vbat of the battery 54; an output signal of a fluid temperature sensor 79 indicative of a working fluid temperature THoil that is a temperature of a working fluid supplied to a hydraulic actuator of each of the engagement devices CD so as to operate each of the engagement devices CB; an output signal of a vehicle-area information sensor 80 indicative of vehicle area information lard: an output signal of a vehicle location sensor 81 indicative of location information Ivp; an output signal of an external-network communication antenna 82 indicative of an communication signal Scorn; an output signal of a navigation system 83 indicative of navigation information Inavi; output signals of drive-assist setting switches 84 indicative of drive-assist setting signals Sset representing a setting made by the vehicle driver for execution of a drive-assist control such as automatic drive control and a cruise control; and an output signal of a shift position sensor 85 indicative of an operation position POSsh of a shift lever 98 (see FIG. 2) provided in the vehicle 10.

The vehicle control apparatus 100 generates various output signals to the various devices provided in the vehicle 10, such as: an engine control command signal Sc that is to be supplied to the engine control device 50 for controlling the engine 14. rotating-machine control command signals Sing that are to be supplied to the inverter 52 for controlling the first and second rotating machines MG1, MG2; hydraulic control command signal Sat that is to be supplied to the hydraulic control unit 56 for controlling the operation states of the engagement devices CB; the communication signal Scorn that is to be supplied to the external-network communication antenna 82; a brake-control command signal Sbra that is supplied to a wheel brake device 86, for controlling a braking torque generated by the wheel brake device 86: a steering-control command signal Sste that is to be supplied to a steering device 88, for controlling steering of wheels (especially, front wheels) of the vehicle 10; and an information-notification-control command signal Sinf that is to be supplied to an information notification device 89, for wanting and notifying information to the vehicle driver.

The vehicle 10 further includes a transceiver 90 and a gateway ECU 92. The transceiver 90 is a device configured to communicate with an external device in the form of a server 200, for example.

The gateway ECU 92 has substantially the same hardware construction as the vehicle control apparatus 100, and is constituted by, for example, a relay device provided to rewrite programs and/or data stored in the rewritable ROM included in the vehicle control apparatus 100. The gateway ECU 92 is connected to the transceiver 90, and is configured to receive and transmit various information between the vehicle control apparatus 100 and the server 200, by using a wireless communication between the transceiver 90 and the server 200.

The server 200 is a system present on a network outside the vehicle 10, and is configured to receive, process, analyze, store and supply the various information such as vehicle state information and vehicle phenomenon information, by using a wireless communication between the server 200 and the vehicle control apparatus 100. The server 200 transmits and receives the various information to and from the vehicle control apparatus 100. The vehicle state information represents, for example, an operation state or driving slate related to driving of the vehicle 10, which is detected by the various sensors or the like. This operation state or driving stale (hereinafter simply referred to as “driving state”) is represented, for example, by the accelerator operation degree θacc, the vehicle running speed V and the operation position POSsh of the shift lever 98. The vehicle state information is transmitted to the server 200, for example, via the transceiver 90 and the gateway ECU 92. The vehicle phenomenon information represents, for example, phenomenons caused in the vehicle 10. It is noted that the vehicle state information may be transmitted to the server 200, also via the external-network communication antenna 82 through the wireless communication.

The vehicle control apparatus 100 executes various control operations. For example, the vehicle control apparatus 100 determines a shifting action of the step-variable transmission portion 20, by using, for example, an AT gear position shift map (not shown), which is a prestored relationship obtained by experimentation or determined by an appropriate design theory, and executes the shift control operation in the step-variable transmission portion 20 as needed. The AT gear position shifting map is a predetermined relationship between two variables in the form of the vehicle running speed V and the required drive force Frdem, for example, which relationship is used to determine the shifting action of the step-variable transmission portion 20 and is represented by shifting lines in two-dimensional coordinates in which the running speed V and the required drive force Prdem are taken along respective two axes.

The vehicle control apparatus 100 has a function serving as an engine control means or portion for controlling the operation of the engine 14 and a function serving as a rotating machine control means or portion for controlling the operations of the first rotating machine MG1 and the second rotating machine MG2 via the inverter 52. and executes a hybrid drive control, for example, using the engine 14, the first rotating machine MG1 and the second rotating machine MG2 through these control functions. The vehicle control apparatus 100 calculates a drive request amount in the form of the required drive force Frdem that is to be applied to the drive wheels 28, by applying the accelerator opening degree Oacc and the vehicle running speed V to, for example, a drive request amount map that is a predetermined relationship. As the drive request amount, a required drive torque Trdcm [Nm]applied to the drive wheels 28, a required drive power Prdem [W] applied to the drive wheels 28 and a required AT output torque applied to the output shaft 22 can be used as well as the required drive force Frdem [N].

For example, when the continuously-variable transmission portion 18 is operated as a continuously variable transmission, the vehicle control apparatus 100 controls the engine 14 and controls a generated electric power Wg of the first rotating machine MG1 so as to attain the engine rotational speed Nc and the engine torque Te at which an engine power Pe achieving the required drive power Prdem is acquired in consideration of an engine optimum fuel consumption point etc. and thereby provides the continuously variable shift control of the continuously variable transmission portion 18 to change the gear ratio γ0 of the continuously variable transmission portion 18.

The vehicle control apparatus 100 selectively establishes the motor running mode or the hybrid running mode as the running mode depending on the driving slate of the vehicle 10, so as to cause the vehicle 10 to run in a selected one of the running modes. For example, the vehicle control apparatus 100 establishes the motor running mode when the required drive power Prdem is in a motor running region smaller than a predetermined threshold value, and establishes the hybrid running mode when the required drive power Prdem is in a hybrid running region equal to or larger than the predetermined threshold value.

The vehicle control apparatus 100 is capable of executing, as a drive control for driving the vehicle 10, a selected one of a manual drive control for driving the vehicle 10 in accordance with driving operations made by the vehicle driver and an automatic drive control for automatically driving the vehicle 10 without depending on the driving operations executed by the vehicle driver. In the automatic drive control, for example, the vehicle 10 is accelerated, decelerated, braked and steered, depending on a target driving state that is automatically determined based on, for example, a map information and a destination point inputted by the vehicle driver. When an automatic drive mode is selected with an automatic-drive selecting switch of the drive-assist setting switches 84 being placed in ON by the vehicle driver, the vehicle control apparatus 100 establishes the automatic drive mode so as to execute the automatic drive control.

By the way, when a particular driving operation, which is, in general, regarded as an erroneous operation, is executed by the vehicle occupant, the control operations are normally limited in the vehicle 10. However, the control operations are not limited depending on a content of the particular driving operation, so that a failure or a durability reduction of a component installed in the vehicle 10 could be caused. For coping with such an issue, it is desirable to identify whether the failure or durability reduction of the component has been caused by the particular driving operation executed by the vehicle occupant. To this end, the vehicle 10 is provided with the particular-driving-operation identification system 8 for identifying whether the failure or durability reduction of the component installed in the vehicle 10 has been caused by the particular driving operation executed by the vehicle occupant. Hereinafter, the particular-driving-operation identification system 8 will be described.

The particular-driving-operation identification system 8 is constituted by the vehicle control apparatus 100 and the server 200, wherein the vehicle control apparatus 100 is provided in the vehicle 10.

For performing functions of the particular-driving-operation identification system 8, the vehicle control apparatus 100 functionally includes a data acquisition means in the form of a data acquisition portion 108, a failure-occurrence determination means in the form of a failure-occurrence determination portion 110, and a particular-driving-operation identification means in the form of a particular-driving-operation identification portion 112.

The data acquisition portion 08 constantly acquires a driving-operation data (information) related to various driving operations of the vehicle occupant For example, the driving operations of the vehicle occupant include an operation (ignition switch ON) for starting the engine 14, an operation of an accelerator pedal, an operation of the brake pedal, an operation for opening or closing a door, an operation for fastening a seat belt, an operation of the shift lever, an operation for turning on or off the air conditioner and an operation for tuning on or off a light. The acquired driving-operation data includes a kind of the driving operation executed by the vehicle occupant and also a length of lime for which the driving operation has been executed. When the driving-operation data is acquired, the running speed V and or the accelerator opening degree θacc upon execution of the driving operation may be acquired together with acquisition of the driving-operation data.

In the present embodiment, the driving-operation data related to the driving operation executed by the vehicle occupant is acquired based on an image data related to an image of the vehicle occupant which is captured by an onboard camera 96 provided on an upper side of a center minor 94 inside a cabin of the vehicle 10. Spec ideally described, the driving operation of the vehicle occupant is identified by analyzing the image of the vehicle occupant, which is represented by the image data, such that the driving operation of the vehicle occupant is constantly is recognized. Further, when the above-described operation of the shirt lever as the driving operation is identified based on the image data, for example, the operation position POSsh of the shift lever 98 is detected by the shirt position sensor 85, so that not only the execution of the operation of live shirt lever but also the operation position POSsh established by operation of the shirt lever is recognized. That is, the data acquisition portion 108 identifies or recognizes the driving operation of the vehicle occupant, based on the image data acquired by the onboard camera 96 and also various information detected by various sensors such as the shift position sensor 85.

When acquiring the driving-operation data, the data acquisition portion 108 transmits the driving-operation data to the server 200 through, for example, the transceiver 90. The server 200 includes a data storage portion 202 that is configured to store therein the driving-operation data transmitted from each of various vehicles (that include the vehicle 10), such that the driving operations represented by driving-operation data transmitted from each of the various vehicles are stored in a chronological order. FIG. 3 is a view showing the driving-operation data stored in the server 200 and representing the driving operations that are listed in the chronological order. Each time when the driving operation is newly recognized, the content and the length of time of the newly recognized driving operation are newly stored whereby the driving-operation data shown in FIG. 3 is updated.

Further, the data acquisition portion 108 constantly acquires a vehicle-state data (information) at a predetermined time interval. The vehicle-state data related to a state of the vehicle 10 include, for example, the engine rotational speed Nc, a rate of change of the engine rotational speed Ne, the MG2 rotational speed Nm of the second rotating machine MG2, a rate of change of the MG2 rotational speed Nm, the working fluid temperature THoil, the engine torque Te, the accelerator opening degree θacc, the vehicle running speed V, the operation position POSsh of the shift lever 98, the gear position of the step-variable transmission portion 20, a running distance of the vehicle 10 and a running time of the vehicle 10, so that these information are constantly acquired as the vehicle-state data at the predetermined time interval. When having acquired the vehicle-state data, the data acquisition portion 108 transmits the vehicle-state data to the server 200 via the transceiver 90, for example. When the vehicle-state data is transmitted to the server 200 from each of the vehicles (in which the vehicle-state data is acquired at the predetermined time interval), the data storage portion 202 of the server 200 stores therein the vehicle-state data in a chronological order. It is noted that the data acquisition portion 108 corresponds to “vehicle-state detection portion” recited in the appended claims.

The failure-occurrence determination portion 110 determines whether the failure or durability reduction of the component has occurred in the vehicle 10, for example, based on information (diagnostic data) provided by various diagnostic devices (not shown) that are installed in the vehicle 10. For example, when slipping of the clutch C1 has been caused due to wear of friction plates of the clutch C1 and is detected by a corresponding one of the diagnostic devices, it is determined that the durability reduction of the clutch C1 has occurred It is noted that the failure-occurrence determination portion 110 corresponds to “failure/durability-reduction detection portion” recited in the appended claims.

When it is determined that the failure or durability reduction of the component has occurred, the particular-driving-operation identification portion 112 determines whether a diagnosis as to whether there have been the particular driving operation or operations (that could cause the failure or durability reduction of the component), is to be executed. The diagnosis as to whether there have been the particular driving operation or operations is executed, when it is determined by the particular-driving-operation identification portion 112 that the diagnosis is to be executed.

When determining that the diagnosis as to whether there have been the particular driving operation or operations is to be executed, the particular-driving-operation identification portion 112 determines whether there have been the particular driving operation or operations, based on the driving-operation data stored in the data storage portion 202. The particular-driving-operation identification portion 112 acquires the driving-operation data transmitted from the server 200, and identifies the particular driving operation (that could cause the failure or durability reduction of the component) among the various driving operations listed in the transmitted driving-operation data. The particular driving operation is the driving operation which could cause the failure or durability reduction of the component, and which is, in general, regarded as an erroneous operation. However, the particular driving operation is not necessarily the erroneous operation executed without intention, but may be also a driving operation executed with intention.

As the particular driving operation, there are various kinds of operations that are determined by an experimentation or an appropriate design theory, such as an operation executed by the vehicle occupant for switching the operation position POSsh of the shift lever 98 from N position (power-transmission cut-off position) to D position (power transmission position) while depressing the accelerator pedal. The particular-driving-operation identification portion 112 pre-stores therein a plurality of kinds of driving operations each corresponding to the particular driving operation, and determines that there have been the particular driving operation or operations, when at least one of the plurality of kinds of driving operations corresponding to the particular driving operation or operations is detected in the driving-operation data. When determining that there have been the particular driving operation or operations, the particular-driving-operation identification portion 112 acquires a content of each of the at least one driving operation corresponding to the particular driving operation or operations and also a length of time for which each of the at least one driving operation has been executed.

When determining that there have been the particular driving operation or operations, the particular-driving-operation identification portion 112 determines whether the failure or durability reduction of the component has been caused by the particular driving operation or operations, based on the vehicle-state data which is stored in the data storage portion 202 and which is related to the state or the vehicle 10 upon execution of the particular driving operation. It is noted that, in a case in which the plurality of driving operations each corresponding to the particular driving operation are detected, namely, the plurality of particular driving operations are detected, it is determined whether each one of the plurality of particular driving operations causes the failure or durability reduction of the component, for example, such that the determination is made first for one of the particular driving operations executed at a point of time closest to a point of time of occurrence of the failure or durability reduction of the component, and is then made for the other or others of the particular driving operations.
The particular-driving-operation identification portion 112 acquires, from the server 200, the vehicle-state data during (or upon) the length (or point) of time for (or at) which the particular driving operation has been executed. Then, the particular-driving-operation identification portion 112 determines whether the vehicle state (including change of the vehicle state) that could cause the failure or durability reduction of the component is detected, in the vehicle-state data during the length of time for which the particular driving operation has been executed. The particular-driving-operation identification portion 112 determines that the vehicle state that could cause the failure or durability reduction of the component b detected, for example, when the rate of change of the engine rotational speed Ne or the working fluid temperature THoil upon execution of the particular driving operation exceeds an upper limit value or an allowable value that are predetermined by an appropriate design theory. It is noted that a plurality of kinds of vehicle states each of which could cause the failure or durability reduction of the component are predetermined and stored in the particular-driving-operation identification portion 112.

When one of the vehicle states which could cause the failure or durability reduction of the component and which are stored in the particular-driving-operation identification portion 112 has been detected during the length of time for which the particular driving operation has been executed, the particular-driving-operation identification portion 112 determines whether the detected vehicle state is relevant to the executed particular driving operation. For example, there is a tendency that the MG2 rotational speed Nm is abruptly reduced by the particular driving operation in the form of switching the operation position POSsh from the N position to the D position while depressing the accelerator pedal. Therefore, in a case in which the MG2 rotational speed Nm has been actually abruptly reduced upon execution of such a particular driving operation (for switching the operation position POSsh from the N position to the D position while depressing the accelerator pedal), it is determined that the detected vehicle state is actually relevant to the executed particular driving operation. Thus, in a case in which the particular driving operation has been executed and then the vehicle slate that could be caused by the executed particular driving operation has been detected, it is determined that the detected vehicle state is actually relevant to the executed particular driving operation. The particular-driving-operation identification portion 112 stores therein the vehicle state which could be relevant to each of the particular driving operations, namely, which could be caused by execution of each of the particular driving operations. Thus, in a case in which one of the particular driving operations has been executed and then the vehicle state that could be relevant to the executed particular driving operation has been actually detected, it is determined that the detected vehicle state has been actually caused by the executed particular driving operation, namely, the detected vehicle state is actually relevant to the executed particular driving operation.

Further, the particular-driving-operation identification portion 112 determines whether the failure or durability reduction of the component is relevant to the vehicle state during the length of time for which the particular driving operation has been executed. For example, there is a tendency that, when the above-described particular driving operation, by which the N position is switched to the D position with the accelerator pedal being depressed, is executed, a load applied to the clutch C1 is abruptly increased while the MG2 rotational speed Km of the second rotating machine MG2 is abruptly reduced. That is, the durability reduction of the clutch C1 as the component could be relevant to the reduction of the MG2 rotational speed Nm as the vehicle state. Thus, in a case in which the reduction of the MG2 rotational speed Nm has been detected as the vehicle state as a result of the execution of the particular driving operation when the durability of the clutch C1 has been reduced, it is determined that the failure or durability reduction of the component is actually relevant to the vehicle state. The particular-driving-operation identification portion 112 stores therein the vehicle state which could be relevant to each kind of the failure or durability reduction of the component, namely, which could cause each kind of the failure or durability reduction of the component. Thus, in a case in which the vehicle state has been detected as a result of the execution of the particular driving operation and then u kind of the failure or durability reduction of the component that could be caused by the detected vehicle state has been actually caused, it is determined that the caused failure or durability reduction of the component has been actually caused by the detected vehicle state, namely, the detected vehicle state is actually relevant to the caused failure or durability reduction of the component.

The particular-driving-operation identification portion 112 determines that there is a possibility that the failure or durability reduction of the component has been caused by the particular driving operation in a case in which the vehicle slate is relevant to the particular driving operation and the vehicle state is relevant to the failure or durability reduction of the component. On the other hand, the particular-driving-operation identification portion 112 determines that the possibility that the failure or durability reduction of the component has been caused by the particular driving operation is absent or low, in a ease in which vehicle state is not relevant to the particular driving operation and/or the vehicle state is not relevant to the failure or durability reduction of the component. In a case in which two or more of the particular driving operations were detected, when determining that the possibility that the failure or durability reduction of the component has been caused by one of the detected two or more particular driving operations is absent or low, the particular-driving-opera lion identification portion 112 then determines whether there is a possibility that the failure or durability reduction of the component has been caused by the other particular driving operation or operations. In this case, when determining the possibility of the failure or durability reduction of the component has been caused by any of the particular driving operation or operations is absent or low, the particular-driving-operation identification portion 112 determines that the failure or durability reduction of the component is unlikely to be caused by any of the particular driving operation or operations.

It is common that most of the particular driving operations do not cause the failure or durability reduction of the component, by the execution only a single lime, and that each of them causes the failure or durability reduction of the component, by the repeated execution a predetermined cumulative number of times or more, or a predetermine number of times during running of the vehicle for a short length of time or for a short distance. In view of this tendency, the particular-driving-operation identification portion 112 counts a cumulative number N of times of execution of each of the particular driving operations, based on the driving-operation data, and determines whether each of the particular driving operations causes the failure or durability reduction of the component, depending on whether the cumulative number N of times exceeded a predetermined value α (that corresponds to “first predetermined value” recited in the appended claims) or not. Specifically described, when the failure or durability reduction of the component has been caused and the cumulative number N of times of execution of the particular driving operation that could be relevant to the caused failure or durability reduction of the component has exceeded the predetermined value a, the particular-driving-operation identification portion 112 determines that the caused failure or durability reduction of the component has been actually caused by the particular driving operation relevant to the failure or durability reduction of the component. The predetermined value α is a threshold value that is obtained by experimentation or determined by an appropriate design theory, for each of the particular driving operations, such that it is considered that the failure or durability reduction of the component has been actually caused by each of the particular driving operations in a ease in which the cumulative number N of times of execution of each of the particular driving operations is larger than the predetermined value α. It is noted that the predetermined value u is set to one (1) for a certain one or ones of the particular driving operations which is likely to cause the failure or durability reduction of the component, even by the execution only twice.

Further, there is a case in which the failure or durability reduction of the component is caused by the repealed execution of the particular driving operation during a short length of time or during running of the vehicle for a short distance. In the present embodiment, the particular-driving-operation identification portion 112 determines whether the failure or durability reduction of the component has been caused by the particular driving operation relevant to the failure or durability reduction of the component, depending on whether a number of limes of execution of the particular driving operation during running of the vehicle 10 for a predetermined distance Ls, is larger than a predetermined value fil (that corresponds to “third predetermined value” recited in the appended claims) or not, or depending on whether a number of times of execution of the particular driving operation during running of the vehicle 10 for a predetermined length Ts of time, is larger titan a predetermined value β2 (that corresponds to “second predetermined value” recited in the appended claims) or not The particular-driving-operation identification portion 112 determines that the failure or durability reduction of the component has been actually caused by the particular driving operation, in a case in which the number of times of execution of the particular driving operation during running of the vehicle 10 for the predetermined distance Ls is larger than the predetermined value β1, or in a case in which the number of times of execution of the particular driving operation during running of the vehicle 10 for the predetermined length Ts of time is larger than the predetermined value β2.

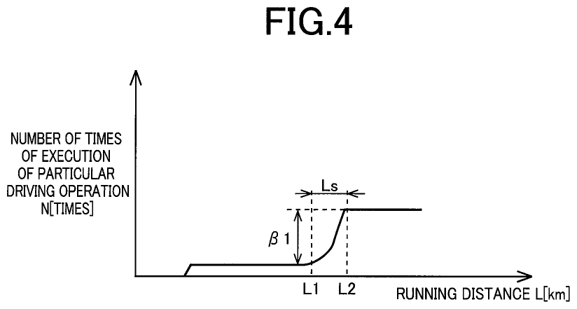

FIG. 4 is a view showing a relationship between a running distance L of the vehicle 10 and a cumulative number N of times of execution of a certain driving operation as a kind of the particular driving operation in a case in which the certain driving operation is executed during running of the vehicle 10. In FIG. 4, its horizontal axis represents the running distance L of the vehicle 10 while its vertical axis represent the cumulative number N of times of execution of the certain driving operation. In an example shown in FIG. 4, the certain driving operation is repeatedly executed during running of the vehicle 10 in a stage in which the vehicle 10 runs for the predetermined distance Ls, from a running distance L1 to a running distance L2, as shown in FIG. 4, so that the number N of times of execution of the certain driving operation is largely increased in the above-described stage. The particular-driving-operation identification portion 112 determines that there is a high possibility that the certain driving operation as the particular driving operation caused the failure or durability reduction of tine component in a case in which the number N of times of execution of the certain driving operation in the stage during running of the vehicle 10 for the predetermined distance Ls(L1-L2) was larger than the predetermined value β1. It is noted that the predetermined distance Ls, predetermined length Ts of time and predetermined values β1, β2 are obtained by experimentation or determined by an appropriate design theory, for each of the particular driving operations, and that each of the predetermined values β1, β2 is a threshold value at which the failure or durability reduction of the component is likely to be initiated.

Further, the possibility that the failure or durability reduction of the component has been caused by the particular driving operation can be categorized into a plurality of levels, for example, depending on the number N of times of execution of the particular driving operation, wherein the plurality of levels may be three levels consisting of high possibility, intermediate possibility and low possibility. Specifically described, for determining a level of the possibility that the failure or durability reduction of the component has been caused by the particular driving operation, two threshold values (smaller and larger threshold values) α1, α2 are provided as the predetermined value α for the number N of times of execution of the particular driving operation, such that the possibility is determined to be low when the number N is smaller than the smaller threshold value α2, such that the possibility is determined to be intermediate when the number N is not smaller than the smaller threshold value α1 and not larger than the larger threshold value α2, and such that the possibility is determined to be high when the number N is larger the larger threshold value α2. Further, more than two threshold values (α1, α2, . . . ) may be provided as the predetermined value α for the number N of times of execution of the particular driving operation, such that the above-described possibility are categorized into more levels each of which is represented by numerals such as (10%, 20% . . . ) It is noted that the threshold values (α1, α2, . . . ) are determined by an experimentation or an appropriate design theory, and may be changed as needed depending on the content of the particular driving operation.

After determining whether the possibility of the failure or durability reduction of the component has been caused by the particular driving operation is present or absent, the particular-driving-operation identification portion 112 informs the presence or absence of the possibility to an inspector through, for example, the information notification device 89. When it is determined that the possibility of the failure or durability reduction of the component has been caused by the particular driving operation is high, the level or degree of the possibility and the content of the particular driving operation are informed to the inspector through the information notification device 89 in the form of an audio device or a display device that are provided in the vehicle cabin, specifically, through a sound emitted from the audio device or an indication displayed in the display device.

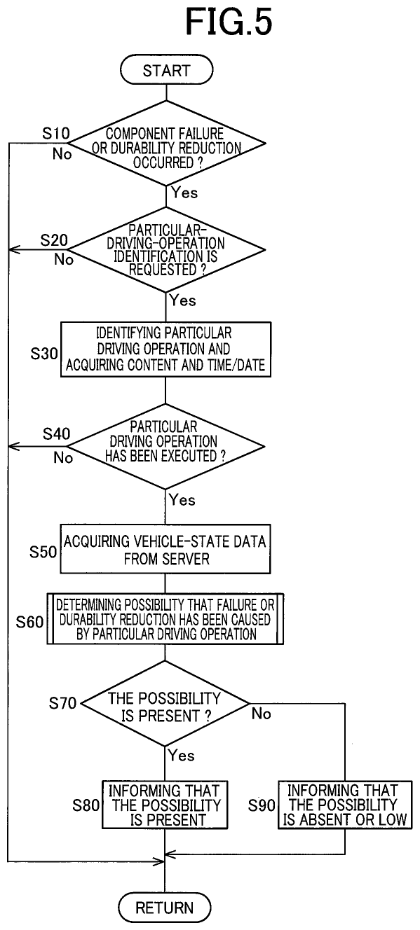

FIG. 5 is a flow chart for explaining a control routine that is to be executed, when the failure or durability reduction of the component of the vehicle 10 has occurred, for determining whether the failure or durability reduction has been caused by the particular driving operation of the vehicle occupant. This control routine is executed when a factor of the failure or durability reduction of the component is to be diagnosed.

The control routine is initiated with step S10 corresponding to control function of the failure-occurrence determination portion 110, which is implemented to determine whether the failure or durability reduction of the component of the vehicle 10 has occurred. This determination is made based on information (diagnostic data) provided by various diagnostic devices (not shown) that are installed in the vehicle 10. When a negative determination is made at step S10, one cycle of execution of the control routine is terminated. When an affirmative determination is made at step S10. step S20 corresponding to control function of the particular-driving-operation identification portion 112 is implemented to determine whether a command requesting a diagnosis has been outputted, wherein the diagnosis is to be made as to whether there have been the particular driving operation or operations. When a negative determination is made at step S20, one cycle of execution of the control routine is terminated. When an affirmative determination is made at step S20, step S30 corresponding to control function of the particular-driving-operation identification portion 112 is implemented to acquire the driving-operation data stored in the data storage portion 202 of the server 200 and identify the particular driving operation or operations from among the driving operations that are listed in the driving-operation data. Further, when the particular driving operation or operations are identified from among the driving operations listed in the driving-operation data, the contents and time of the identified particular driving operation or operations are acquired. At step S40 corresponding to control function of the particular-driving-operation identification portion 112, it is determined whether there have been the particular driving operation or operations, based on result of implementation of step S30. When a negative determination is made at step S40, one cycle of execution of the control routine is terminated.

When an affirmative determination is made at step S40, step S50 corresponding to control function of the particular-driving-operation identification portion 112 is implemented to acquire, from the server 200, the vehicle-state data stored in the data storage portion 202 of the server 200 and related to the vehicle state (i.e., state of the vehicle 10). Then, step S60 corresponding to control function of the particular-driving-operation identification portion 112 is implemented to verify whether the failure or durability reduction of the component has been caused by the particular driving operation or operations identified at step S30.

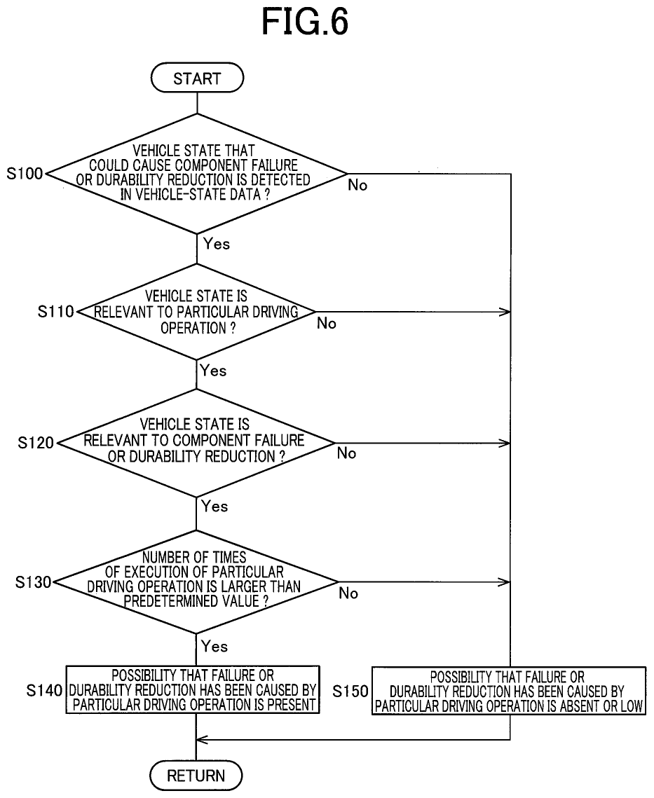

Referring to flow chart of FIG. 6, there will be described step S60 corresponding to the control function of the particular-driving-operation identification portion 112, which is implemented to determine whether there is a possibility that the failure or durability reduction of the component has been caused by the particular driving operation or operations. It is noted that when two or more particular driving operation have been identified at step S30, the determination (as to the possibility that the failure or durability reduction of the component has been caused by the particular driving operation) is made first for one of the particular driving operations executed at a point of time closest to a point of time of occurrence of the failure or durability reduction of the component, and is then made for the other or others of the particular driving operations.

As shown in FIG. 6, a control sub-routine shown in the How chart of FIG. 6 is initiated with step S100 at which it is determined whether the vehicle state (including change of the vehicle state) that could cause the failure or durability reduction of the component, has been detected in the acquired vehicle-state data. When a negative determination is made at step S100, the control flow goes to step S150 at which it is determined that the possibility that the failure or durability reduction of the component has been caused by the particular driving operation is absent or low, and then one cycle of execution of the control sub-routine is terminated. When an affirmative determination is made at step S100, step S110 is implemented to determine whether the vehicle state detected at step S100 is relevant to the particular driving operation. When a negative determination is made at step S110, the control flow goes to step S150 at which it is determined that the possibility that the failure or durability reduction of the component has been caused by the particular driving operation is absent or low, and then one cycle of execution of the control sub-routine is terminated. When an affirmative determination is made at step S110, step S120 is implemented to determine whether the vehicle state detected at step S100 is relevant to the failure or durability reduction of the component. When a negative determination is made at step S120, the control flow goes to step S150 at which it is determined that the possibility that the failure or durability reduction of the component has been caused by the particular driving operation is absent or low, and then one cycle of execution of the control sub-routine is terminated. When an affirmative determination is made at step S120, step S130 is implemented to determine whether the cumulative number N of times of execution of the particular driving operation is larger than the predetermined value a. When an affirmative determination is made at step S130, the control flow goes to step S140 at which it is determined that the possibility that the failure or durability reduction of the component has been caused by the particular driving operation is present since it is it is considered that the vehicle state has been caused by execution of the particular driving operation, and has caused the failure or durability reduction of the component. When a negative determination is made at step S130, the control flow goes to step S150 at which ii is determined that the possibility that the failure or durability reduction of the component has been caused by the particular driving operation is absent or low. After implementation of step S140 or S150, one cycle of execution of the control sub-routine is terminated,

Referring back to the flow chart of FIG. 5, step S70 corresponding to control function of the particular-driving-operation identification portion 112 is implemented to determine whether the possibility that the failure or durability reduction of the component has been caused by the particular driving operation is present, based on result of determination made at step S60. When a negative determination is made at step S70, the control flow goes to step S90 corresponding to control function of the particular-driving-operation identification portion 112, which is implemented to determine that the possibility that the failure or durability reduction of the component has been caused by the particular driving operation is absent or low, and to inform the inspector that the possibility is absent or low. When an affirmative determination is made at step S70, the control flow goes to step S80 corresponding to control function of the particular-driving-operation identification portion 112, which is implemented to determine that the possibility that the failure or durability reduction of the component has been caused by the particular driving operation is present, and to inform the inspector that the possibility is present. (00631 As described above, in the present embodiment, it is determined by the particular-driving-operation identification portion 112 whether there has been the particular driving operation that is likely to cause the failure or the durability reduction of the component installed in the vehicle 10, based on the driving-operation data. When the failure or the durability reduction of the component has been caused, it can be determined whether the failure or the durability reduction of the component has been caused by the particular driving operation or not, depending on the vehicle state when the particular driving operation has been executed.

Further, in the present embodiment, the driving-operation data related to the driving operation executed by the vehicle occupant can be acquired based on the image data related to the image of the vehicle occupant which is captured by the onboard camera 96, and the driving operation executed by the vehicle occupant can be recognized based on the driving-operation data. Further, with the driving-operation data being acquired, it is possible to determine whether the particular driving operation or operation have been executed, depending on whether at least one driving operation each corresponding to the particular driving operation is found or not in the acquired driving-operation data. Whether the failure or durability reduction of the component has been caused by execution of the particular driving operation or not can be determined based on the cumulative number of times of execution of the particular driving operation relevant to the failure or the durability reduction of the component, the number of limes of execution of the particular driving operation during running of the vehicle 10 for the predetermined length of time Ts, or the number of times of execution of the particular driving operation during running of the vehicle 10 for the predetermined distance Ls.

There will be described another embodiment of this invention. The same reference signs as used in the above-described first embodiment will be used in the following second embodiment, to identify the functionally corresponding elements, and descriptions thereof are not provided.

### Second Embodiment

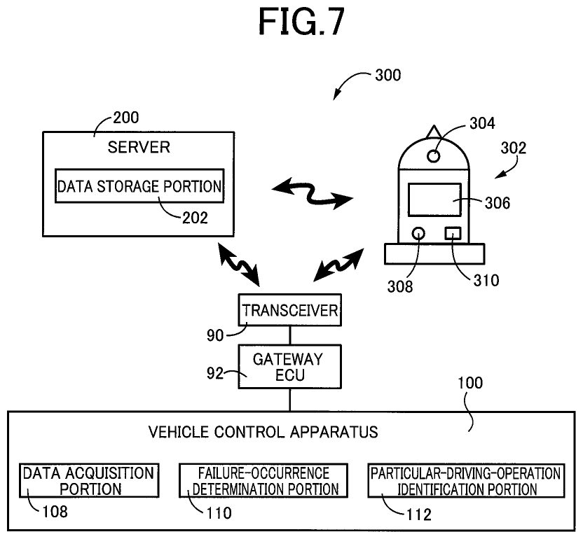

FIG. 7 is an overall construction of a particular-driving-operation identification system 300 according to a second embodiment of the present invention. In FIG. 7, the vehicle 10 and the various sensors configured to provide various information to the vehicle control apparatus 100 are not shown.

The particular-driving-operation identification system 300 is constituted by the vehicle control apparatus 100, the server 200 and a conversation robot 302.

The conversation robot 302 is provided inside the vehicle 10, and is capable of conversating with the vehicle occupant. The conversation robot 302 has a shape that is formed according to preference of the vehicle occupant. The conversation robot 302 includes a camera 304, a display 306, a loudspeaker 308, a microphone 310 and an electronic control device (not shown), wherein the loudspeaker 308 and the microphone 310 are provided for enabling conversation with the vehicle occupant, and the electronic control device is provided for controlling operations of the conversation robot 302. The conversation robot 302 is configured to receive and transmit various information from and to the vehicle control apparatus 100 and the server 200 through wireless communications.

The conversation robot 302 conversates with the vehicle occupant, and constantly acquires a content of the conversation as a conversation data. Further, where an operation command can be supplied to each of various devices of the vehicle 10 through a voice of the vehicle occupant, the conversation robot 302 constantly acquires the voice of the vehicle occupant as a voice data. Thus, the driving-operation data is constantly acquired based on contents of the acquired conversation data and voice data. Each of the conversation data and voice data corresponds to “sound data” recited in the appended claims. Further, the conversation robot 302 is capable of monitoring the driving operation of the vehicle occupant through the camera 304, so that the conversation robot 302 can constantly acquire content of the driving operation of the vehicle occupant, by identifying the driving operation, based on an image data acquired by the camera 304 That is, the operation of the vehicle occupant can be determined through the image data that is acquired by the camera 304 provided in the conversation robot 302 in place of the onboard camera 96 provided in the vehicle 10. The voice data, conversation data and image data of the vehicle occupant, which are acquired by the conversation robot 302, are stored in a storage device (not shown) of the conversation robot 302 or stored in the server 200 through the wireless communication.

Further, the storage device of the conversation robot 302 pre-stores therein a plurality of kinds of driving operations each corresponding to the particular driving operation, and constantly determines whether there have been the particular driving operation or operations. This determination may be made by taking account of also information such as the operation position POSsh that are constantly supplied, as needed, from the vehicle control apparatus 100 to the conversation robot 302 through the wireless communication. Further, when determining that the particular driving operation has been executed, the conversation robot 302 may interrogate the vehicle occupant whether he or she has really executed the particular driving operation or not. and may advice the vehicle occupant not to execute such a particular driving operation, if he or she answers yes to the interrogation It is noted that the interrogation about the particular driving operation may be acquired as the conversation data, and may be stored as needed in the storage device of the conversation robot 302.

In the event of the failure or durability reduction of the component, it is determined whether the particular driving operation or operations have been executed, based on content of the voice data or conversation data of the vehicle occupant stored in the storage device of the conversation robot 302. Further, during or after running of the vehicle 10, the conversation robot 302 may interrogate the vehicle occupant whether he or she has executed the particular driving operation, and may determine that the particular driving operation has been executed, if the conversation data that he or she answers yes to the interrogation has been detected. Moreover, the determination as to whether the particular driving operation or operations have been executed can be made more accurately, with the determination being made additionally based on the image data acquired through the camera 304 of the conversation robot 302. Thus, the conversation robot 302 can perform a function of determining whether the particular driving operation or operations have been executed or not. After it is determined that the particular driving operation or operations have been executed, it is determined whether there is a possibility that the Failure or durability reduction of the component has been caused by execution of the particular driving operation or operations, in substantially the same manner as described above with reference to FIGS. 5 and 6.

Thus, the determination as to whether the particular driving operation or operations have been executed or not may be made based on the sound data acquired by the conversation robot 302, wherein the sound data includes the conversation data related to the conversation made between the conversation robot 302 and the vehicle occupant and or the voice data related to the voice of the vehicle occupant. Further, the determination may be made based on. In addition to the sound data, the image data acquired by the conversation robot 302.

As described above, in this second embodiment, it is possible to determine whether the particular driving operation or operations have been executed and to acquire contents of the particular driving operation or operations, based on the sound data and/or the image data acquired by the conversation robot 30.

While the preferred embodiments of the present invention have been described in detail by reference to the drawings, it is to be understood that the invention may be otherwise embodied.

For example, in the above-described first embodiment, the driving operations executed by the vehicle occupant are constantly recognized based on the image data constantly acquired by the onboard camera 96 and stored as the driving-operation data in the server 200. However, all of the driving operations do not necessarily have to be stored, as long as at least one or ones of the driving operations each corresponding to the particular driving operation are stored in the server 200, so that a data volume of the driving-operation data stored in the server 200 can be reduced.

In the above-described first embodiment, each time information related to the various driving operations of the vehicle occupant is acquired as the driving-operation data, and the acquired driving-operation data is stored in the data storage portion 202 of the server 200. However, the acquired driving-operation data does not necessarily have to be stored in the data storage portion 202 of the server 200, but may be stored in a data storage portion provided in the vehicle 10, for example. Further, the vehicle-state data related to the vehicle state does not necessarily have to be stored in the data storage portion 202, either, but may be stored in the data storage portion provided in the vehicle 10, for example. Where the driving-operation data and the vehicle-state data are stored in the data storage portion of the vehicle 10, the server 200 is not required, so that the particular-driving-operation identification system can be constituted by only parts or portions provided in the vehicle 10. Moreover, the data storage portion may be provided in each of the vehicle 10 and the server 200, as in an arrangement in which the driving-operation data is stored in the data storage portion of the vehicle 10 while the vehicle-state data is stored in the data storage portion of the server 200, for example.

In the above-described embodiments, the failure or durability reduction of the component installed in the vehicle 10 is detected based on the information provided by the various diagnostic devices installed in the vehicle 10. However, the occurrence of the failure or durability reduction of the component may be determined based on a report from the vehicle occupant or a result of an inspection made by the inspector.

In the above-described second embodiment, the conversation robot 302 is configured to store therein the sound data (such as the voice data and the conversation data) acquired during running of the vehicle 10, and to determine whether the particular driving operation or operations have been executed, based on the stored sound data. However, after the failure or durability reduction of the component has occurred, the conversation robot 302 may interrogate the vehicle occupant whether he or she has really executed the particular driving operation.

In the above-described first embodiment, the image inside the vehicle cabin, which is represented by the image data, is captured by the onboard camera 96 provided inside the vehicle cabin. However, the image inside the vehicle cabin may be captured by a camera that is to be used in the automatic drive control or any other camera capable of capturing the image inside the vehicle cabin.

In the above-described embodiments, when the failure or durability reduction of the component has occurred, it is determined, based on the driving-operation data, whether the particular driving operation or operations likely to cause the failure or durability reduction of the component have been executed. However, this arrangement is not essential. Specifically, each time when any driving operation is executed, it may be determined whether the executed driving operation corresponds to the particular driving operation, and a flag is set when the executed driving operation corresponds to the particular driving operation, so that it is determined whether the particular driving operation or operations have been executed depending on whether the flag has been set or not, for example, when the failure or durability reduction of the component has occurred.

In the above-described embodiments, the vehicle 10 is provided with the power transmission apparatus 12 including the continuously-variable transmission portion 18 and the step-variable transmission portion 20 that are connected to each other in series. However, the provision of the power transmission apparatus 12 including the continuously-variable transmission portion 18 and the step-variable transmission portion 20 is not essential. For example, in the vehicle to which the present invention is applied, an engine and a rotating machine may be connected to each other without provision of the differential mechanism 22 or the like therebetween, and a step-variable transmission may be provided between drive wheels and the drive power sources (i.e., the engine and the rotating machine), wherein the step-variable transmission may be replaced with a belt-type continuously-variable transmission.

In the above-described embodiments, the vehicle 10 is a hybrid electric vehicle having the drive power sources in the form of the engine 14 and the second rotating machine MG2. However, the vehicle to which the present invention is applied docs not have to be necessarily a hybrid electric vehicle, but may be an engine vehicle or electric vehicle having only one drive power source in the form of the engine 14 or rotating machine, for example. That is, the present invention is not limited to vehicles having certain types of drive power sources and certain types of drive systems, for example.

It is to be understood that the embodiments described above are given for illustrative purpose only, and that the present invention may be embodied with various modifications and improvements which may occur to those skilled in the art.

### NOMENCLATURE OF ELEMENTS

8, 300: particular-driving-operation identification system

10: vehicle

112: particular-driving-operation identification portion

202: data storage portion

What is claimed is:

1. A particular-driving-operation identification system for identifying whether a failure or a durability reduction of a component installed in a vehicle has been caused by a driving operation of an occupant of the vehicle or not.
the particular-driving-operation identification system comprising:
a data storage portion configured to store therein a driving-operation data related to the driving operation of the vehicle occupant and a vehicle-state data related to a vehicle state that is a state of the vehicle: and
a particular-driving-operation identification portion configured to determine whether there has been a particular driving operation that is the driving operation likely to cause the failure or the durability reduction of the component, based on the driving-operation data stored in the data storage portion.
wherein, when determining that there has been the particular driving operation in a case in which the failure or the durability reduction of the component has been caused, the particular-driving-operation identification portion is configured to identify, based on the vehicle-state data stored in the data storage portion, whether the failure or the durability reduction of the component has been caused by the particular driving operation or not, depending on the vehicle state when the particular driving operation has been executed.

2. The particular-driving-operation identification system according to claim 1, wherein the driving-operation data is to be acquired based on an image data related to an image of the vehicle occupant.

3. The particular-driving-operation identification system according to claim 1, wherein the driving-operation data is to be acquired based on a sound data related to a voice or a conversation of the vehicle occupant.

4. The particular-driving-operation identification system according to claim 1,
wherein the particular-driving-operation identification portion is configured to pre-store therein at least one driving operation each corresponding to the particular driving operation, and
wherein the particular-driving-operation identification portion is configured to determine that there has been the particular driving operation, when at least one of the at least one driving operation is detected in the driving-operation data.

5. The particular-driving-operation identification system according to claim 1,
wherein the particular-driving-operation identification portion is configured to determine whether or not the failure or the durability reduction of the component has been caused by the particular driving operation that is relevant to the failure or the durability reduction of the component, depending on (i) whether a cumulative number of limes of execution of the particular driving operation is larger than a first predetermined value or not, (ii) whether a number of times of execution of the particular driving operation during running of the vehicle for a predetermined length of time, is larger than a second predetermined value or not, or (iii) whether a number of times of execution of the particular driving operation during running of the vehicle fora predetermined distance, is larger than a third predetermined value or not.

6. The particular-driving-operation identification system according to claim 1, further comprising:
a failure/durability-reduction detection portion configured to detect the failure or the durability reduction of the component: and
a vehicle-state detection portion configured to acquire the vehicle-state data and detect the vehicle state when the particular driving operation has been executed.
wherein the particular-driving-operation identification portion is configured to determine that the failure or the durability reduction of the component detected by the failure/durability-reduction detection portion has been caused by the executed particular driving operation, when determining that the vehicle state detected by vehicle-state detection portion has been caused by execution of the particular driving operation and has caused the failure or the durability reduction of the component detected by the failure durability-reduction detection portion.
